(19) United States
(12) Patent Application Publication
(10) Pub. No.: US 2006/0244226 A1
(43) Pub. Date: Nov. 2, 2006

(54) Shopping cart tether system and method

(76) Inventor: V. John Ondrasik, Commerce, CA (US)

Correspondence Address: GORDON & REES LLP, 101 WEST BROADWAY, SUITE 1600, SAN DIEGO, CA, 92101, US

(21) Appl. No.: 11/117,955

(22) Filed: Apr. 28, 2005

(51) Int. Cl. B62D 39/00

(52) U.S. Cl. 280/33.992

(57) ABSTRACT

A tether system for shopping carts in which a plurality of carts each have an anchor member at a location which is exposed when another cart is nested into the rear of the cart. An elongated tether of pliable material can be secured to the rear cart of a nested series of carts with the tether extending forwardly and looped around the anchor on the forward cart of the series of carts in order to secure the carts together.

### BACKGROUND OF THE INVENTION

The present invention relates to shopping carts or other wheeled vehicles and it is particularly concerned with nestable carts which can be nested together for storage and transportation purposes, and with a tether system for holding nested carts together as they are pushed or pulled as a unit from one location to another.

Shopping carts are typically left by customers in store parking lots after the contents have been unloaded into the customers' cars. Store personnel must collect carts from the parking lot, nesting them together so that they can all be pushed back into the front of the store or a convenient location adjacent the store to be picked up by customers for use while shopping. Nested carts tend to separate when pushed or pulled, making them difficult to transport. Store personnel will often use a rope to tie to the basket or handle bar of carts so as to resist separation and make the carts easier to pull or push, often with hooks and/or cinching devices to attach the rope to the carts. However, this can be inconvenient and takes time in tying and untying the carts.

### SUMMARY OF THE INVENTION

It is an object of the present invention to provide a new and improved tether system and method for transporting a plurality of shopping carts which are nested together.

According to one aspect of the present invention, a tether system for shopping carts or the like is provided, which comprises a plurality of carts, each cart having a wheeled base, a rear frame projecting upwardly from the base and having a handle, and a basket secured to the rear frame and projecting forwardly from the frame, the rear end of each cart having an opening to allow nesting of the forward end of a second, identical cart into the rear end of the first cart, whereby a series of carts can be nested together, each cart having an anchor member at a location which is exposed when another cart is nested into the rear of the cart, and an elongated tether of pliable material for linking to the rear cart of a nested series of carts and extending forwardly and looping around the anchor on the forward cart of the series of carts.

In an exemplary arrangement, the tether is looped over the handle or other structure at the rear end of the rear cart and side-by-side portions of the tether extend forwardly to loop around the anchor. This arrangement allows a series of nested carts to be tethered together without having to tie or knot a rope or the like over part of the cart framework. When the nested carts have arrived at their destination, all that needs to be done is to unwind the tether from the anchor member, release one end of the tether and pull the opposite end, unwinding the tether from the handle. The carts are then ready for use. This is much faster and more convenient than using a rope tether which is tied or knotted to carts. The tether may be a cord, rope or any elongate line. Alternatively, it may be of a smooth, flat ribbon-like material or plastic so that it can be readily detached from the carts on arrival at their destination. In another arrangement, a hook may be secured at one end of the tether for hooking over the handle or other structure such as the gate pivot rod, with the tether extending forwardly to wrap or loop around the anchor.

The anchor may be provided at any convenient and readily accessible location on the cart which will not interfere with use of the cart by a shopper. Most shopping carts have a rear gate which is pivoted to the rear end of the cart and is pushed upwardly by the forward end of a second cart when nested into the first cart. The rear gate is often associated with a folding child seat at the rear of the basket. In this type of cart, the anchor may comprise a loop, L-shaped structure or T-shaped structure secured to a lower end region of the gate which will be lifted up when carts are nested together. When a rear cart is nested into the rear end of a first cart, the gate of the first cart is lifted up to lie almost level with the top of the basket, and the anchor will face upwardly and be readily accessible. When a series of carts are nested together, the loop or anchor of the front cart will still be exposed and accessible.

In my co-pending application Ser. No. 10/401,341 filed Mar. 26, 2003 and Ser. No. 10/836,169 filed Apr. 30, 2004, the contents of which are incorporated herein by reference, a nestable shopping cart is described in which a fixed child seat is secured to the cart adjacent the upper end of the rear frame so as to project forwardly from the frame, and a rear gate is pivoted below the child seat to close an open rear end of the basket and also allow carts to be nested together. In this case, the anchor may be provided on the top of the rear wall of the child seat (i.e. the back rest for a child in the seat who is facing rearwardly), rather than on the pivoted gate. The cart described in these applications also has a caster lift device. This device will lift the rear wheels of a forward cart when a rear cart is nested into the rear end of a forward cart. With this arrangement, when a row of carts are nested together, only the front wheels of each cart and the rear wheels of the rearmost cart will contact the ground, making a row of nested carts easier to steer. With the tether system of this invention, such a row of carts will be even easier to transport from one location to another, although the tether system will still work even with carts which do not have any caster lift mechanism.

Instead of securing the anchor at the lower end of the gate or back rest of a fixed child seat, it may alternatively be secured at another location, such as the front wall of a basket. The anchor may be formed with the wire grille of the cart, or permanently welded at an appropriate location on the cart. Alternatively, the anchor may be a separate part which is attached to the cart and may be used to retrofit existing carts.

According to another aspect of the present invention, a method of tethering and transporting a plurality of shopping carts is provided, which comprises the steps of:

nesting together a plurality of shopping carts with the forward end of each cart apart from a front cart nested into the rear end of the cart in front;

anchoring an elongated tether to the handle of the rear cart of the row of nested carts with the remainder of the tether projecting forwardly along the top of the nested carts;

looping the tether around an anchor located at an exposed position on the forward cart of the row of nested carts;

pulling or pushing the row of carts to a desired location; and

on arrival of the carts at the desired location, unwinding the tether from the anchor and releasing the tether from the handle.

The tether may be engaged at an intermediate point in its length, around the handle or other appropriate location on the rear cart with side-by-side portions of the tether projecting forwardly and looped around the anchor. In order to release the tether, it is first unwound from the anchor, and then one end of the anchor is released while the other end is pulled to unwind the tether from the handle or other location on the rear cart.

The tether may be of lightweight but strong material which can be readily stored in the pocket of store personnel when not in use, such as plastic ribbon or cord, fabric, or other types of cords or straps. The system and method of this invention requires only a minor modification of each cart to provide a suitable anchor on the pivoted gate or the rear wall of a child seat. Existing carts may be easily retrofitted to provide an anchor. Carts can then be transported much more easily and efficiently when retrieved from store parking lots and the like. When a row of carts is being pulled using the tether system, and another cart is being picked up, the operator can easily unwind the tether from the front cart of the row, nest the front cart into the rear end of the additional cart, and then re-wind the tether around the anchor of the new front cart. No time consuming knotting, unknotting, or running a rope through a front end of a cart is required.

### BRIEF DESCRIPTION OF THE DRAWINGS

The present invention will be better understood from the following detailed description of some exemplary embodiments of the invention, taken in conjunction with the accompanying drawings in which like reference numerals refer to like parts and in which:

FIG. 1 is a perspective view of a shopping cart with an anchor according to a first embodiment of the present invention;

FIG. 1A is an enlarged view of circled area A of the cart of FIG. 1, illustrating the anchor;

FIG. 2 illustrates a row of nested carts being transported using the tether system according to the first embodiment of the invention;

FIG. 3 is a perspective view of a shopping cart with anchors according to a second embodiment of the present invention;

FIG. 3A is an enlarged view of the circled area A of the cart of FIG. 3, illustrating one of the anchors;

FIG. 3B is an enlarged view of the circled area B of the cart of FIG. 3, illustrating a caster lift member;

FIG. 4 illustrates a row of the carts of FIG. 3 nested together and being pulled using a tether system according to the second embodiment of the invention;

FIG. 5 illustrates two of the carts of FIG. 3 nested together, illustrating operation of the caster lift mechanism;

FIG. 5A is an enlarged view of the circled portion A in FIG. 5;

FIG. 6 is a perspective view of a shopping cart with a rear pivoted gate and child seat similar to that of FIG. 1, but with a modified anchor;

FIG. 6A is an enlarged view of the circled portion A in FIG. 6;

FIG. 7 is a perspective view of a shopping cart with an anchor according to another embodiment of the invention; and

FIG. 7A is an enlarged view of the circled portion A in FIG. 7.

### DETAILED DESCRIPTION OF THE DRAWINGS

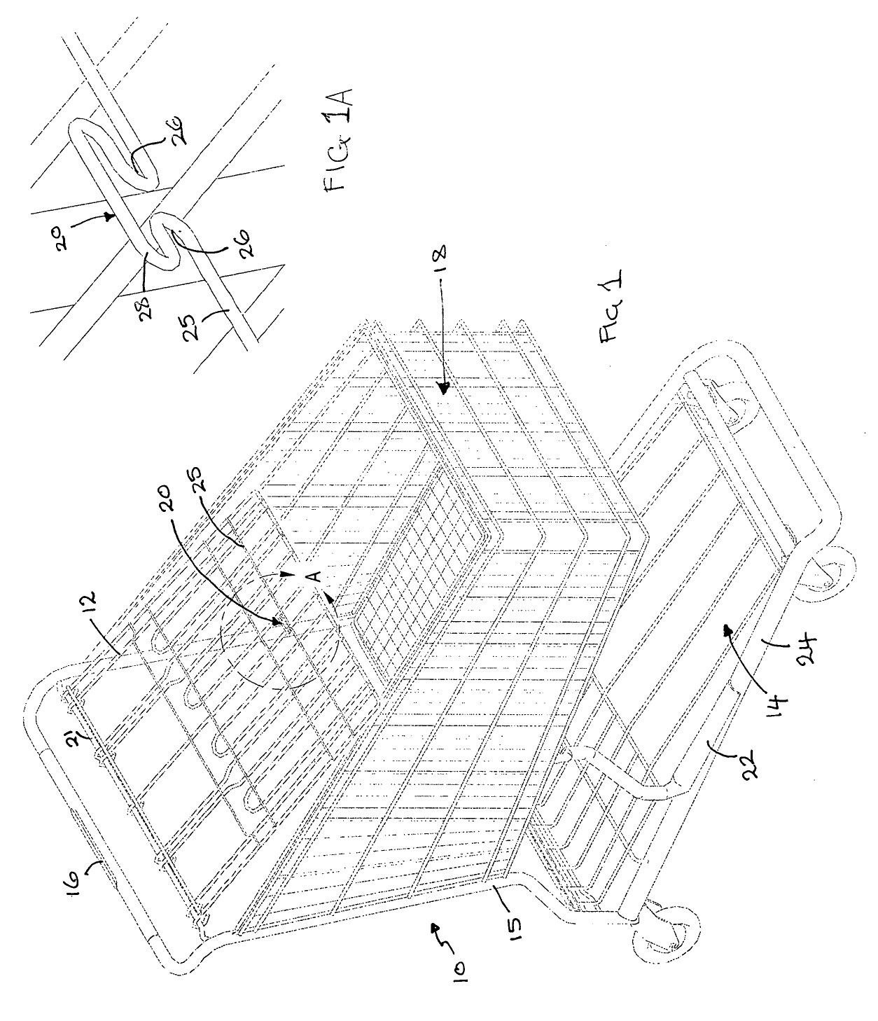

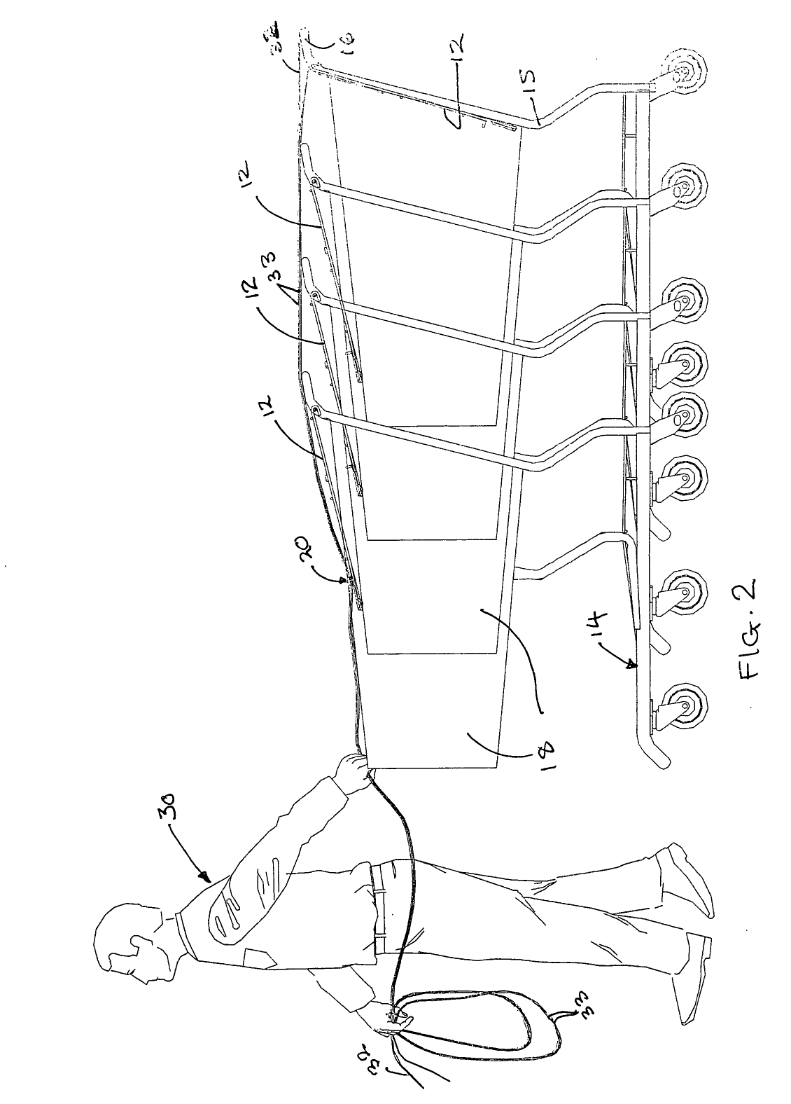

FIGS. 1, 1A and 2 illustrate a shopping cart and tether system according to a first embodiment of the present invention. The shopping cart 10 of FIG. 1 is similar to a conventional shopping cart with a pivoted rear gate 12 to allow nesting of two carts. Cart 10 has a wheeled base 14, a rear frame 15 projecting upwardly from the rear end of the base and having a handle 16 at its upper end for use in pushing the cart, and a basket 18 having a rear end secured to the frame and projecting forwardly from the frame at a position raised above the wheeled base. The basket is open at its rear end and the pivoted gate 12 is lowered when the cart is in use so as to close the rear opening of the basket, as is known in the field. The pivoted gate will normally include a child seat foldable between a flat position lying against the gate and a deployed position tilted away from the gate to provide a seat for a small child when an adult is shopping, as is also well known in the field. Details of the child seat are omitted for clarity in FIG. 1, but it will be understood that such a conventional seat will normally be provided in cart 10.

The shopping cart 10 of this embodiment is modified by providing an anchor 20 at a location close to the lower end of gate 12. Anchor 20 projects inwardly when the gate is in the lowered position during normal use of the cart, and projects upwardly when the gate is raised as indicated in FIG. 1, as it will be when carts are nested together. Cart 10 may also have optional sleeves 22 on the side frame members 24 of the wheeled base 14, which may be engaged by caster lift members as described in my co-pending application Ser. No. 10/836,169 referenced above when two or more carts are nested together.

Anchor 20 is illustrated in more detail in FIG. 1A. It is formed by shaping a central portion of a cross wire 25 to provide a raised loop which has an indented region or waist 26 at its lower end and an enlarged upper portion 28. The cross wire 25 can then be welded across a lower portion of the gate 12 as indicated in FIG. 1. Existing shopping carts can be modified easily and inexpensively to provide such an anchor. Instead of a wire loop, the anchor may comprise any structure with an enlarged portion and indented waist, such as a T-shaped or L-shaped rod or the like.

A tether system using the anchor 20 is illustrated in FIG. 2. A store clerk 30 retrieving carts from a parking lot will nest the carts together as indicated in FIG. 2. FIG. 2 illustrates four nested carts, but it will be understood that a greater or lesser number of carts may readily be tethered in a similar manner. The carts are nested together in the conventional manner, by pushing one cart into the rear end of a forward cart, simultaneously raising the rear gate 12 of the forward cart into an upwardly facing position as indicated in FIG. 2. At the same time, caster lift members, if present on the wheeled base of the forward cart, will be engaged by sleeves 22 of the rear cart, lifting the rear wheels of the forward cart slightly off the ground. This process is continued until a desired number of carts is collected. In order to tether the carts together, the clerk simply takes a line or tether 32 and loops it over the handle 16 of the rear most cart so that the tether 32 is doubled over and side-by-side portions 33 of the tether can be extended forwardly over the nested carts. Instead of looping the tether around the handle 16, it may be looped about other convenient structures on the cart, such as the pivot rod 21 on which gate 12 is pivoted. The tether is then looped once around the anchor 20 of the forward cart to engage in the waist region 26. The free ends of the tether may be loosely gripped by the store clerk while pulling or pushing the row of carts by gripping the front end of the forward cart, as illustrated in FIG. 2. Alternatively, the free ends of the tether may be placed in the basket while the clerk pushes the row of carts from the rear.

Once the carts have been moved to a desired location, which may be a cart corral or storage area in front of a store or inside a store, the tether 32 can be detached from the carts quickly and easily. All that is necessary is for the tether to be unwound from anchor 20, and the operator then pulls one end of the tether until the tether is also unwound from handle 16. This leaves the nested row of carts ready for use by shoppers. When the operator or cart is transporting carts as in FIG. 2, and finds another cart to add to the row, they simply unwind the tether from the front cart, and then push the row of carts into the rear end of the new cart. The tether is then quickly wound around the anchor 20 of the new front cart of the row of nested carts, and the operator is immediately able to pull the row of carts back to the store or to another location for pick up of one or more additional carts.

The tether may be of any suitable pliable material such as rope, cord, plastic strip material, fabric belt material, or the like. It may be a relatively lightweight strip material which can be readily stored in the operator's pocket when not in use. The tether system using anchor 20 of this invention is much less time consuming than current techniques of tethering carts which involve knotting a rope or the like around part of the cart frame or basket. This takes more time in untying a row of tethered carts and in adding more carts to a tethered row of carts.

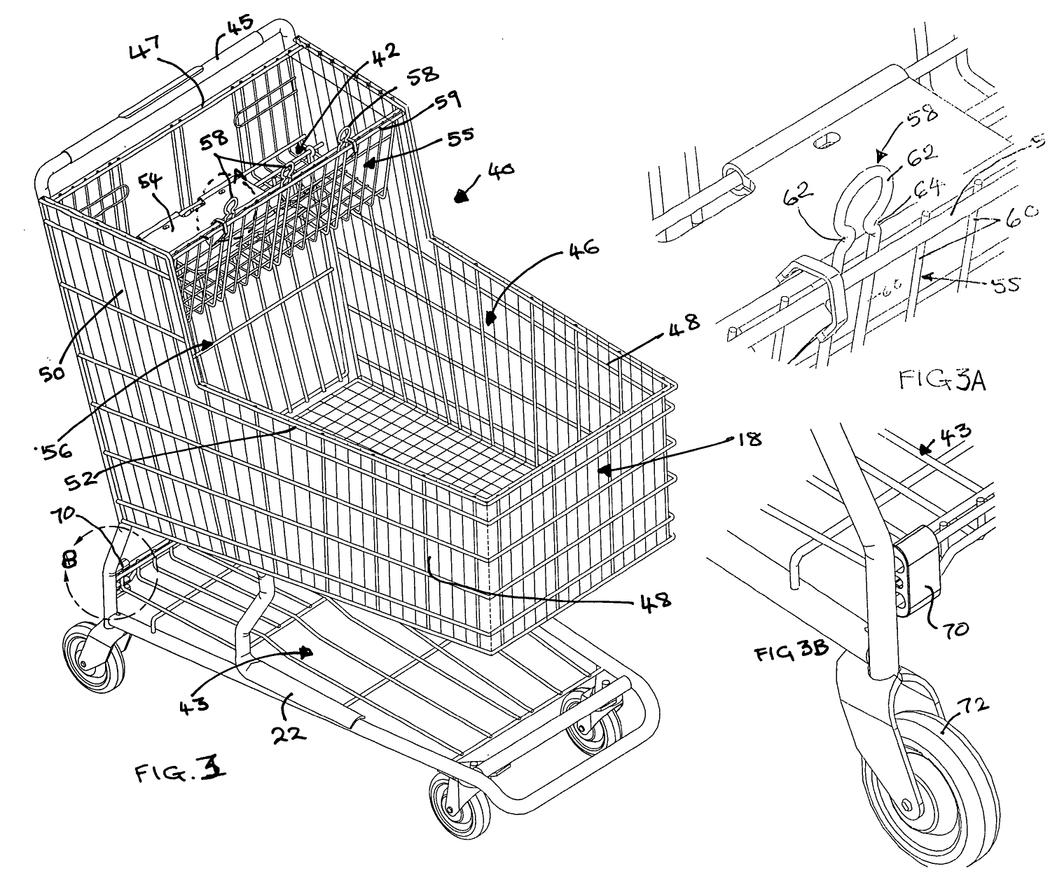

FIGS. 3 to 5 illustrate a tether system according to a second embodiment of the present invention applied to a different type of cart. The shopping cart 40 of FIG. 3 has a fixed child seat 42 as described in my co-pending application Ser. No. 10/836,169 referenced above and incorporated herein by reference. As in the previous embodiment, shopping cart 40 has a wheeled base 43, a rear upright frame 44 with a handle 45 at its upper end, and a basket 46 projecting forwardly from frame 44. Unlike the previous embodiment, basket 46 has stepped side walls 48 each having a raised rear portion 50 and a downwardly stepped forward portion 52. The child seat 42 is secured between the raised rear portions 50 of the side walls, and has a base 54 and back rest 55. The rear end of the basket beneath the base 54 is open and a pivoted gate 56 is secured in the open end of the basket. When the forward end of a rear cart is pushed into the rear end of a front cart, the gate 56 will be pushed upwardly beneath the seat so that the forward end portion of the basket of the rear cart engages in the rear end of the basket of the forward cart. Sleeves 22 as in the first embodiment may be provided on the side members of the frame of base 43.

In order to provide for the tether system of this embodiment, the cart 40 is modified to provide three spaced anchors 58 across the upper edge or cross bars 59 of the seat back rest 55. The central anchor 58 will be used for the tether system. The additional anchors on each side, in addition to the central anchor, may be optionally used to carry bags or the like while purchased merchandise is transported from a store to the shopper's car, or to carry the shopper's handbag or a shopping bag while in the store. In alternative embodiments, a single anchor may be used and it may be positioned at other locations on the cart, such as on the front wall.

All three anchors 58 are identical and one of the anchors is illustrated in detail in FIG. 3A. As can be seen in FIG. 3, the back rest is partially formed by a series of generally vertical, parallel wires 60 which are welded at their upper ends to cross bars 59. In order to form each anchor 58, an adjacent pair of the upright wires or members 60 may be formed by a single bar or rod which is bent over at its mid-point to form a loop 62 with an indented waist 64. The bar is then welded to the cross bars 58 at a location just below waist 64, and the two remaining side-by-side portions are extended first downwardly and then rearwardly to form part of the back rest and base of the seat, as can be seen in FIG. 3. Alternatively, the anchors 58 may be simply welded to the upper ends of respective pairs of wires 60. This technique may be used to retrofit existing carts. Instead of a loop with an indented waist as in the illustrated embodiment anchor 58 may be a T-shaped or L-shaped structure, or any other structure with an enlarged upper portion and indented portion.

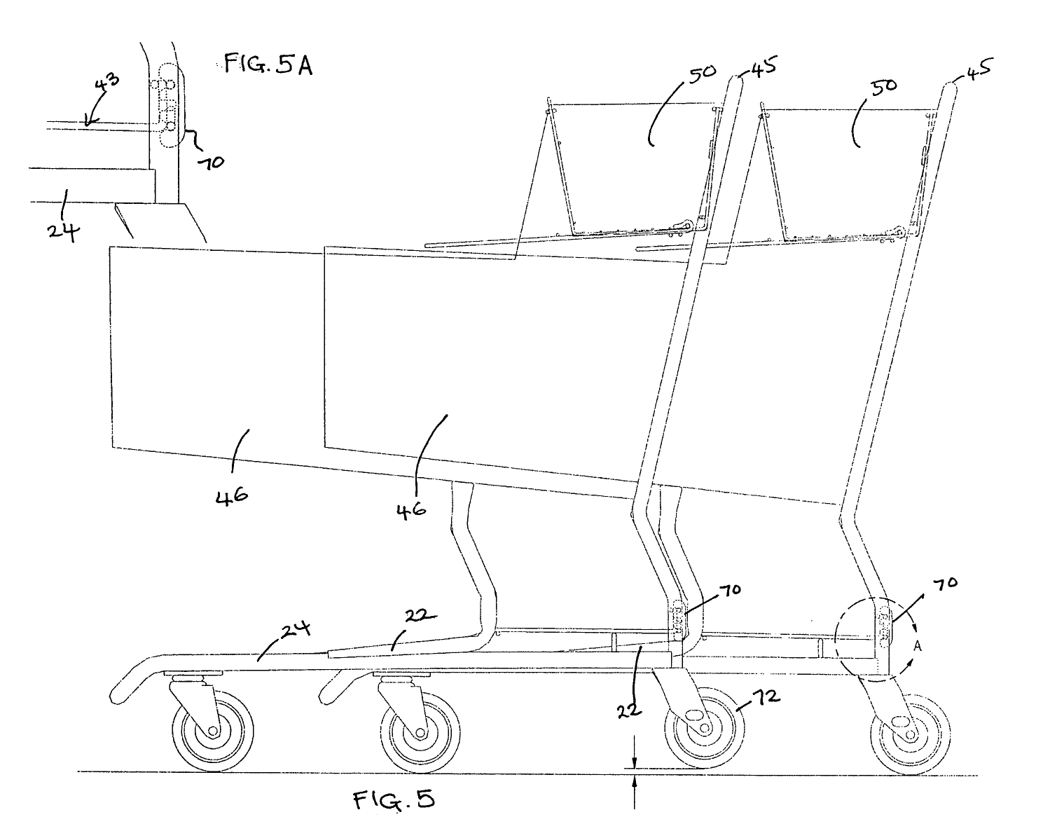

FIGS. 3, 3B and 5 illustrate an optional caster lift member 70 which may be snapped onto the rear end of the base tray of the cart as indicated. Two such lift members may be provided, one on each side of the rear end of the tray. As illustrated in FIG. 5, the lift members 70 of a first cart will engage the sleeves 22 of a cart nested into the first cart from the rear, lifting the rear wheels 72 of the first cart from the ground.

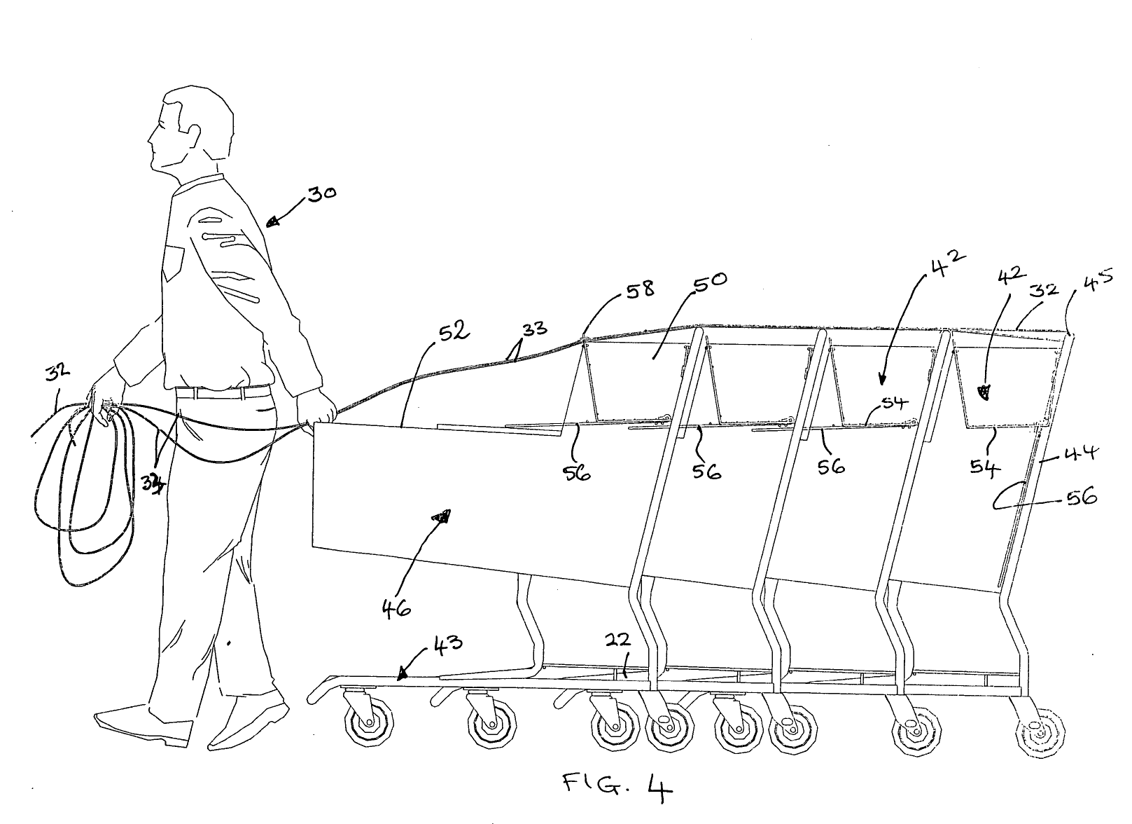

A tether system for carts as illustrated in FIG. 3, using the central anchor 56 of a cart, is illustrated in FIG. 4. A store clerk 30 retrieving carts from a parking lot will nest the carts together as indicated in FIG. 4. FIG. 4 illustrates four nested carts, but it will be understood that a greater or lesser number of carts may readily be tethered in a similar manner. The carts are nested together in the conventional manner, by pushing one cart into the rear end of a forward cart, simultaneously raising the rear gate 56 of the forward cart into an upwardly facing position against the base of the child seat 42, as indicated in FIG. 4A. At the same time, the caster lift member 22 on the wheeled base of the rear cart will engage under the rear end of the base of the forward cart, lifting the rear wheels of the forward cart slightly off the ground. This process is continued until a desired number of carts is collected. In order to tether the carts together, the clerk simply takes a line or tether 32 as in the previous embodiment, and loops it over the handle 45 of the rear most cart so that the tether 32 is doubled over and side-by-side portions 33 of the tether can be extended forwardly over the nested carts. The tether may alternatively be looped over the upper end 47 of the front wall of the child seat. The tether is then looped once around the central anchor 58 of the forward cart to engage in the waist region 64, and the free ends of the tether may be loosely gripped by the clerk in front of the row of carts, as in FIG. 4, while the clerk grips the front end of the basket of the forward cart to pull or push the row of carts. Alternatively, the free ends of the tether are simply placed into the basket while the clerk pushes or pulls the row of carts from the rear or from the front.

Once the carts have been moved to a desired location, which may be a cart corral or storage area in front of a store or inside a store, the tether 30 can be detached from the carts quickly and easily. All that is necessary is for the tether to be unwound from anchor 58, and the operator then pulls one end of the tether until the tether is also unwound from handle 45. This leaves the nested row of carts ready for use by shoppers. When the operator or store clerk is transporting carts as in FIG. 4, and finds another cart to add to the row, they simply unwind the tether from the front cart, and then push the row of carts into the rear end of the new cart. The tether is then quickly wound around the anchor 58 of the new front cart of the row of nested carts, and the operator is immediately able to pull the row of carts back to the store or to another location for pick up of one or more additional carts.

In the above embodiments, the tether is looped over the handle or other rear portion of the rear cart with both ends extended forwardly for wrapping around the anchor. In an alternative embodiment, a hook may be secured to one end of the tether for engaging the handle or other rear portion of the cart with the tether extending forwardly to wrap around the anchor.

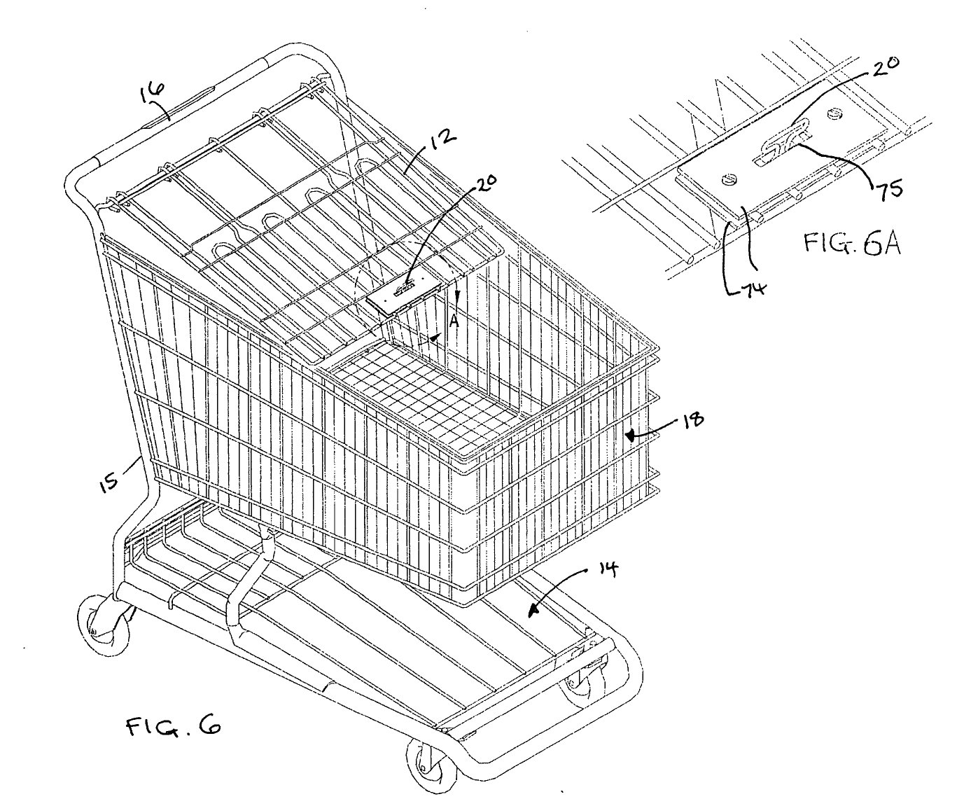

FIGS. 6 and 6A illustrate an alternative method for mounting an anchor 20 on a shopping cart with a gate 25 as in FIG. 1. This can be used to retrofit existing carts. In this alternative, rather than welding the base of the anchor onto the cart, it is instead held between two plates 74 which are releasably secured together by bolts or screw fasteners. The upper plate has an opening 75 through which the anchor 20 projects. Another alternative retrofit option is a snap-on anchor.

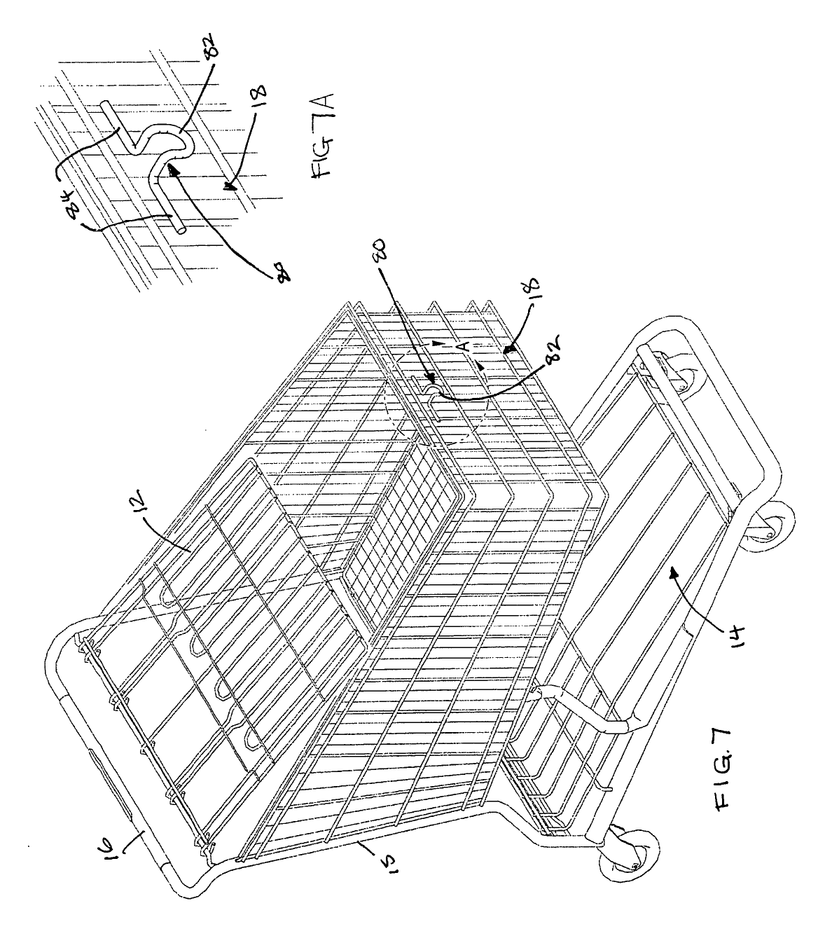

FIGS. 7 and 7A illustrate an alternative anchor position. Although this is illustrated for a cart as illustrated in FIG. 1, similar positioning may be used for an alternative anchor on the cart of FIG. 3. In FIGS. 7 and 7A, an anchor 80 is secured to the front wall 18 of the cart 10. The anchor 80 comprises a generally U-shaped loop or anchor portion 82 with transverse, oppositely directed base legs 84 at the ends of the U-shape. The base legs 84 can be welded to the front of the basket as indicated, or releasably secured at the same position in a similar manner to that illustrated in FIGS. 6 and 6A. The anchor portion is bent downwardly to form a hook-like shape so as to better retain a tether loop which is wound around it to secure nested carts together. The tether system and method will be the same as described above in connection with the first two embodiments.

Although a caster lift mechanism is used on the cart in both the first and second embodiment described above, it should be understood that this mechanism is not essential for the tether system of this invention, and the caster lift members 70 may be eliminated in other embodiments. The tether may be of lightweight but strong material which can be readily stored in the pocket of store personnel when not in use, such as plastic ribbon or cord, fabric, or other types of cords, lightweight ropes, or straps. The anchor need not be of metal but may alternatively be of rigid plastic or other material of sufficient strength. The system and method of this invention requires only a minor modification of each cart to provide a suitable loop or anchor on the pivoted gate or the back rest of a child seat. Existing carts may be easily retrofitted to provide an anchor or loop. Carts can then be transported much more easily and efficiently when retrieved from store parking lots and the like. When a row of carts is being pulled or pushed using the tether system, and another cart is being picked up, the operator can easily unwind the tether from the front cart of the row, nest the front cart into the rear end of the additional cart, and then re-wind the tether around the anchor of the new front cart. No time consuming knotting and unknotting is required.

Although some exemplary embodiments of the invention have been described above by way of example only, it will be understood by those skilled in the field that modifications may be made to the disclosed embodiments without departing from the scope of the invention, which is defined by the appended claims.

I claim:

1. A tether system for shopping carts or the like, comprising:
a plurality of carts, each cart having a wheeled base, a rear frame projecting upwardly from the base and having a handle, and a basket secured to the rear frame and projecting forwardly from the frame;
the rear end of each cart having an opening to allow nesting of the forward end of a second, identical cart into the rear end of the first cart, whereby a series of carts can be nested together;
each cart having an anchor member at a location which is exposed when another cart is nested into the rear of the cart; and
an elongated tether of pliable material for securing to the rear cart of a nested series of carts and looping around the anchor on the forward cart of the series of carts.

2. The system as claimed in claim 1, wherein each anchor member comprises a rod bent to form a structure having an enlarged upper portion and an indented waist, whereby the tether portions can be wrapped around the waist of the structure

3. The system as claimed in claim 1, wherein each shopping cart basket has a rear opening for allowing nesting of the basket of a rearward cart into the basket, and a pivoted rear gate movable between a lowered position covering the rear opening when the cart is in use and a raised position when a second cart is nested into the rear opening in the basket, and the anchor member is secured to a lower portion of the rear gate facing inwardly into the basket, whereby the anchor member will face upwardly when a second cart is nested into the first cart to raise the pivoted gate.

4. The system as claimed in claim 3, wherein a cross bar is secured across the inner face of the pivoted rear gate and the anchor comprises a raised central portion of the cross bar.

5. The system as claimed in claim 4, wherein the anchor has an enlarged outer portion and an indented waist portion which adjoins the remainder of the cross bar.

6. The system as claimed in claim 4, wherein the cross bar is welded to the pivoted rear gate.

7. The system as claimed in claim 4, wherein the cross bar is releasably secured to the pivoted rear gate.

8. The system as claimed in claim 1, wherein each shopping cart basket has side walls each having a raised rear portion and a fixed child seat secured between the raised rear portions of the side walls, the child seat having a base and a back rest spaced forwardly from the rear frame, the basket being open beneath the child seat, and a rear gate pivoted below the child seat, the rear gate being movable between a lowered position closing the open rear end of the basket when in use and a raised position when a second cart basket is nested into the rear end of the basket, the back rest of the child seat having an upper cross bar and the anchor being mounted on the back rest to project upwardly from the upper cross bar.

9. The system as claimed in claim 8, wherein the anchor is located at the center of the back rest, and at least two additional anchors are mounted on the back rest, one on each side of the central anchor, said anchors comprising means for engaging the handles of shopping bags when the cart is in use.

10. The system as claimed in claim 8, wherein the anchor comprises a rod bent to form a structure having an upper enlarged portion and a lower indented waist portion around which the tether can be wound.

11. The system as claimed in claim 1, wherein the base of each cart has a peripheral frame comprising a front member and spaced side members, and a cross member at the rear end of the cart, and at least one caster lift member is mounted on the cross member to engage a side member of the base of a rear cart when the rear cart is nested into the rear end of the forward cart, whereby the rear wheels of the forward cart are raised from the ground.

12. The system as claimed in claim 1, wherein the basket has a front wall and the anchor member is mounted on the front wall.

13. The system as claimed in claim 12, wherein the anchor member is of downwardly facing hook-shape.

14. A method of tethering and transporting a plurality of shopping carts, comprising the steps of:
nesting together a plurality of shopping carts comprising a front cart, a rear cart, and at least one intervening cart between the front and rear cart, with the forward end of each cart apart from the front cart nested into the rear end of the cart in front;
securing an elongated tether to the rear cart of the row of nested carts with the tether projecting forwardly along the top of the nested carts;
looping the tether around an anchor on the front cart;
pulling or pushing the row of carts to a desired location; and
on arrival of the carts at the desired location, unwinding the tether from the anchor and releasing the tether from the rear cart.

15. The method as claimed in claim 14, wherein the step of securing the tether to the rear cart comprises engaging the tether around a rear portion of the rear cart at an intermediate point in its length with side-by-side portions of the tether projecting forwardly along the top of the nested carts, and the step of releasing the tether comprises releasing one end of the tether and pulling the other end of the tether to unwind it from the handle after the side-by-side portions of the tether have been unwound from the anchor.

16. A shopping cart, comprising:
a wheeled base;
a rear frame projecting upwardly from the base and having a handle;
a basket secured to the rear frame and projecting forwardly from the frame;
the rear end of each cart having an opening to allow nesting of the forward end of a second, identical cart into the rear end of the first cart, whereby a series of carts can be nested together; and
a projecting anchor member on a part of the cart which is exposed when a second cart is nested into the cart, the anchor member providing a winding location for holding a tether looped around the anchor member to anchor the cart when the cart is the forward cart of a series of nested carts.

17. The cart as claimed in claim 16, wherein the anchor member comprises a structure having an enlarged outer portion and an indented waist portion for engaging a tether wound around the anchor member.

18. The cart as claimed in claim 16, wherein the basket has a rear opening for allowing nesting of the basket of a rearward cart into the basket, and a rear gate is pivotally mounted in the rear opening for movement between a lowered position covering the rear opening when the cart is in use and a raised position when a second cart is nested into the rear opening in the basket, and the anchor member is secured to a lower portion of the rear gate facing inwardly into the basket, whereby the anchor member will face upwardly and project above the rear gate when a second cart is nested into the first cart to raise the pivoted gate.

19. The cart as claimed in claim 16, wherein the basket has side walls each having a raised rear portion and a fixed child seat secured between the raised rear portions of the side walls, the child seat having a base and a back rest spaced forwardly from the rear frame, the basket being open beneath the child seat, and a rear gate pivoted below the child seat, the rear gate being movable between a lowered position closing the open rear end of the basket when in use and a raised position when a second cart basket is nested into the rear end of the basket, the back rest of the child seat having an upper cross bar and the anchor member being mounted on the back rest to project upwardly from the upper cross bar.

20. The cart as claimed in claim 16, wherein the basket has a front wall and the anchor member is located on the front wall.
